(19) United States
(12) Patent Application Publication
(10) Pub. No.: US 2005/0255953 A1
(43) Pub. Date: Nov. 17, 2005

(54) Band Drive System for Telescopes, LIDAR and Other Instruments

(75) Inventor: Timothy David Puckett, Ellijay, GA (US)

Correspondence Address: TIM PUCKETT, 170 ACORN LANE, ELLIJAY, GA, 30540, US

(73) Assignee: Timothy David Puckett, Ellijay, GA (US)

(21) Appl. No.: 10/709,539

(22) Filed: May 12, 2004

(51) Int. Cl. F16H 27/02; F16H 7/02; F16H 7/04

(52) U.S. Cl. 474/149; 474/153; 474/148

(57) ABSTRACT

A band drive system, providing both speed and torque reduction for astronomical telescopes, light detection and ranging systems, and other instruments requiring precision pointing about an axis of revolution. The system consists of two drive disks of unequal sizes coupled by a thin stainless steel drive band.

### BACKGROUND OF THE INVENTION

There are many circumstances in the use of astronomical telescopes where it is desirable or necessary to both point and track astronomical objects with extreme precision. A lack of precision in pointing results in a loss of time because it then becomes necessary to perform small pointing adjustments to center the object within the telescope's field of view. A lack of precision in the telescope's tracking rate will require the implementation of some method to monitor and correct for irregularities in the telescope's tracking rate. Commonly used methods for monitoring a telescope's drive rate require the purchase and installation of additional equipment just for this purpose.

A variety of telescope drive systems have been devised to provide increased precision in pointing and tracking. Most of these drive systems have their own inherent limitations and/or are expensive or difficult to manufacture. Such systems include worm drives, chain drives, and friction drives.

Worm drives employ a gear and matching worm and may include a built in slip clutch to facilitate manual positioning of the telescope. Such drives are commonly attached directly to the telescope's drive axis and are subject to several inherent design limitations. Such limitations include a high loading on the gear's teeth where they are in contact with the worm, which will result in mechanical wear of both the gear's teeth and of the worm. Such drives are subject to velocity errors if grit contaminates the system. If great care is not taken during the manufacture of the gear, then the drive may exhibit unacceptable tooth to tooth errors. This results from the gear's teeth not being evenly and precisely spaced. The drive may also exhibit a cyclic periodic error during every worm revolution due to limitations in a machinist's ability to produce a worm with exactly the correct pitch for the gear diameter. Finally, the drive may exhibit errors due to decentering of the gear about the drive axis, especially if a built in clutch is provided. Additional errors will also occur if the worm is not precisely aligned to the gear in height and tangent angle. The most common solution employed to reduce the majority of these errors is simply to use a larger drive. This solution quickly becomes extremely expensive for larger gear sizes.

Chain drives were developed to overcome the inherent weaknesses of worm drives. Chain drives consist of one or more chains mounted under tension between two disks of unequal size. Indeed, even multiple reduction stages have been employed to achieve greater accuracy. The chains are not unlike the chain commonly found on a bicycle, but are of higher precision. Chain drives are subject to velocity errors related to the thickness of each link, the length of each link, and the sizes of the disks. Either a very large disk must be used or extremely thin chains must be used to minimize these errors. Chain drives are subject to breakage since the chain is held under very high tension. This causes the pivot points in the chain's links to wear. Additionally, a chain drive must be oiled periodically to prevent excessive friction from developing in the pivot points of each link.

Friction drives were developed to overcome many of the inherent deficiencies inherent in both worm drives and chain drives. A friction drive consists of a primary disk made from stainless steel which is directly driven by an auxiliary disk of much smaller dimension. The auxiliary disk is in direct frictional contact with the primary disk. Since the area of physical contact between the two disks is extremely small, the auxiliary disk must be engaged with considerable force or it will slip, rather than drive the primary disk. There are several inherent weaknesses in the friction drive design. The primary and secondary disks must be ground to an extremely high precision since any errors will be directly transmitted to the telescope. The bearings which support the secondary disk must likewise be of extremely high precision and be able to withstand the extremely high loads placed upon them. This is usually difficult to achieve since the bearings tend to be rather small, similar in size to the auxiliary disk. Any grit, sand or other contaminants that get between the two disks will cause rather abrupt tracking errors as well as damaging the surfaces of the disks. Contaminants have a tendency to become impacted into the surfaces of the disks. An unforeseen source of pointing and tracking errors arose after the implementation of early friction drive designs. As mentioned, the contact area between the two disks is extremely small. This contact area is under extreme pressure so that slippage between the disks does not occur. It turns out that the contact surfaces of the disks can become permanently deformed over time due to compression and permanent deformation of the metal comprising the contact surfaces. The primary disk, due to compression, can become slightly elliptical in shape after continued use. The auxiliary disk, if left in a stationary position for long periods of time, can develop a local surface deformation that is permanent. The only solution to these problems, other than rebuilding the complete system, is the addition of tape encoders and a high speed position feedback system. Such a system is rather expensive and is subject to its own inherent problems.

### BRIEF DESCRIPTION OF THE SEVERAL VIEWS OF THE DRAWINGS

FIG. 1 is a perspective view of the invention.

FIG. 2 is a plan view thereof.

### DETAILED DESCRIPTION OF THE INVENTION

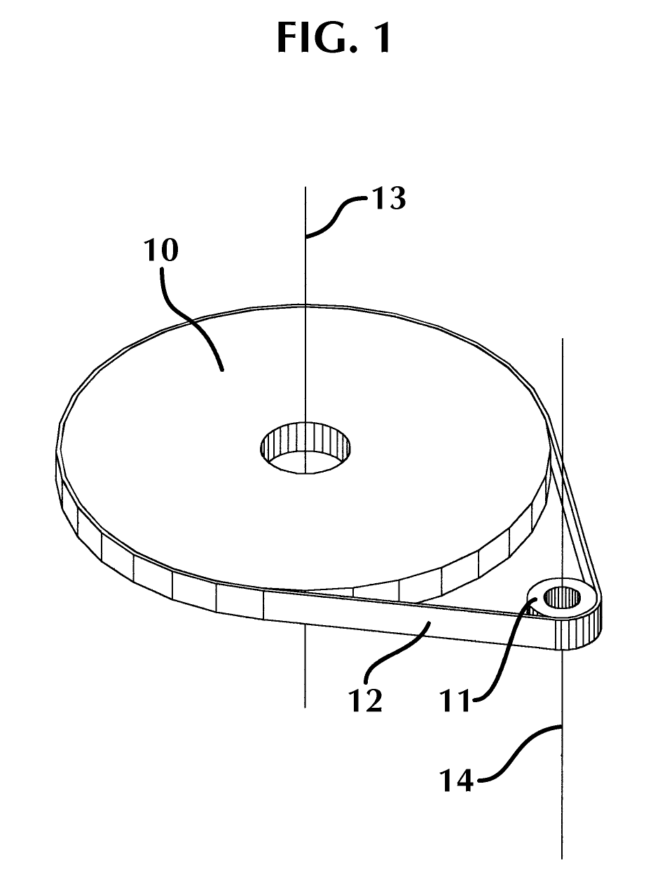

The instrument of the invention, as shown in FIG. 1, for example, is a perspective view of the band drive system, it being understood that mounting mechanisms for the invention form no part of the claimed design. The instrument includes a larger disk 10 whose axis 13 is coaxial with the axis of revolution of the application to which the invention is physically attached, a smaller disk 11 whose axis 14 is parallel to axis 13, and a stainless steel band 12.

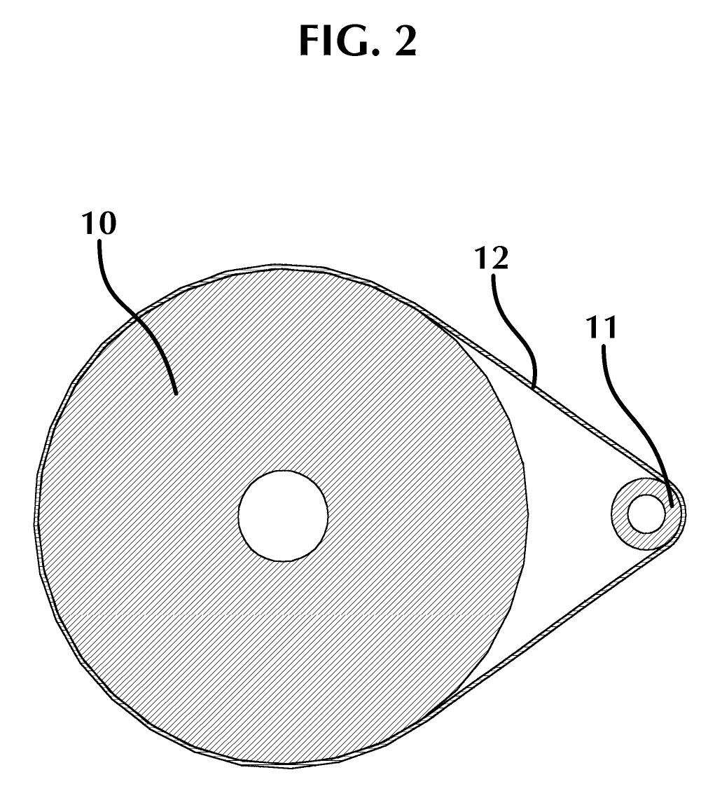

FIG. 2 is a plan view of the invention, clearly showing the spacing between the larger disk 10 and the smaller disk 11. The thickness of band 12 is exaggerated for clarity, it being understood that said thickness should be chosen based on the properties of the stainless steel from which said band is made and the diameter of said smaller disk.

The smaller disk may be machined with a groove on the outer surface of the disk, with the groove's edges forming a ridge to facilitate forced tracking of the band within the confines of the outer edges of the disk. This will prevent the band from possibly riding off the outer edge of the smaller disk. Utilizing the smaller disk in such fashion for forced tracking of the band has the advantage, due to the inherent stiffness of the stainless steel band, of similarly preventing the band from coming off the larger disk, without the need to machine a similar groove on the larger disk.

The invention is operated by initiating rotation of the smaller disk about its axis of revolution, using whatever mechanism, hereinafter referred to as the “mechanism”, that the user of this invention chooses to produce said rotation. As the smaller disk rotates, the band transfers the rotational velocity at the smaller disk's outer edge to the outer edge of the larger disk, rotating it in similar fashion but at a reduced speed. Thus the invention behaves as a speed reducer, the reduction being equal to the ratio of the sizes of the disks.

The ratio of the sizes of the two disks, hereinafter referred to as “disk ratio”, results in a reduction of the force required to rotate said application to which the invention is physically attached. The reduction in required force is in direct proportion to the disk ratio. A disk ratio of 8:1, for example, will require 8 times less force to rotate said application. This is a desirable benefit since smaller, less powerful drive motors, for example, may be employed to rotate the smaller disk.

The disk ratio also results in a reduction of errors from the mechanism. The disk ratio will reduce errors in the mechanism in direct proportion. This is also a desirable benefit for the user because it reduces the costs associated with the implementation of a suitable mechanism. For example, if the user chooses to use a relatively large disk ratio of 10:1 then even a small and relatively inexpensive worm drive may be utilized as the mechanism, since said worm drive's errors will be reduced by a factor of 10.

One distinct advantage of the invention, compared to other designs described herein, is the invention's inherent resistance to grit and other contaminants. The pressure that the band exerts on each disk is proportional to the tension applied to the band. Since the pressure is distributed over very large areas of contact between the band and each disk, grit and other contaminants do not become embedded into the disk surfaces. Additionally, the exerted pressure is well below the surface deformation limit of even pure aluminum, which is a very soft structural material compared to many aluminum alloys, brass, bronze or steel. Theory and calculations predict that such contaminants would produce negligible pointing and tracking errors. Errors due to contaminants are virtually unobservable in actual use on a large astronomical telescope. Notably, the invention exhibits virtually zero wear since the contaminants do not become imbedded into the disks.

The disks can be easily fabricated by making aluminum castings, for example, which could then be taken to a local machine shop and turned to diameters specified by the user of this invention.

The stainless steel band, used in this invention, is utilized in industrial applications. Such bands are readily available from several manufacturers. Stainless steel, due to its high tensile strength and resistance to corrosion, is the preferred material from which to fabricate said band.

The invention provides, therefore, a simple and inexpensive drive assembly for astronomical telescopes, light detection and ranging systems, and other instruments that require precision pointing about an axis of revolution.

It will be appreciated that while a particular embodiment of the invention has been shown and described, modifications may be made. It is intended in the claims to cover all modifications which come within the true spirit and scope of the invention.

1. A band drive system for turning about an axis of revolution astronomical telescopes, light detection and ranging systems, and other instruments comprising: a larger disk being coaxial with said axis of revolution; a smaller disk of lesser diameter than said larger disk, mounted adjacent to and in the same plane as said larger disk with the axes of both said disks being parallel, and spaced apart from said larger disk so as to avoid direct physical contact; a thin stainless steel band encircling both said disks for the purpose of providing for the transfer of motion from said smaller disk to said larger disk.

2. A band drive system employing multiple application of said system, wherein said smaller disk of the primary application is both driven and connected in coaxial fashion to the larger disk of the secondary application, with any additional application being connected to the previous application in similar coaxial fashion, for the purpose of providing additional benefit from said system.
